(19) United States
(12) Patent Application Publication
(10) Pub. No.: US 2024/0079599 A1
(43) Pub. Date: Mar. 7, 2024

(54) ANODELESS ALL-SOLID-STATE BATTERY CAPABLE OF ACHIEVING UNIFORM DEPOSITION OF LITHIUM

(71) Applicants: Hyundai Motor Company, Seoul (KR); Kia Corporation, Seoul (KR)

(72) Inventors: Young Jin Nam, Seoul (KR); Hong Suk Choi, Hwaseong (KR); Seon Hwa Kim, Cheongju (KR); Hee Soo Kang, Seoul (KR); Jae Min Lim, Suwon (KR); Sang Wan Kim, Anyang (KR)

(73) Assignees: Hyundai Motor Company, Seoul (KR); Kia Corporation, Seoul (KR)

(21) Appl. No.: 18/138,858

(22) Filed: Apr. 25, 2023

(30) Foreign Application Priority Data
Sep. 2, 2022 (KR) 10-2022-0111238

(51) Int. Cl. H01M 4/62

(52) U.S. Cl. CPC H01M 4/628; H01M 4/625; H01M 4/626; H01M 2004/021

(57) ABSTRACT

Disclosed is an anodeless all-solid-state battery which may effectively control local volume expansion due to lithium deposited during charging of the battery. The all-solid-state battery includes an anode current collector, an intermediate layer located on the anode current collector, a solid electrolyte layer located on the intermediate layer, a cathode active material layer located on the solid electrolyte layer and including a cathode active material, and a cathode current collector located on the cathode active material layer. The intermediate layer includes carbon particles and metal particles alloyable with lithium, and the carbon particles include a first carbon material, e.g., as a spherical carbon material, and a second carbon material, e.g., a linear carbon material.

### CROSS-REFERENCE TO RELATED APPLICATION

This application claims under 35 U.S.C. § 119(a) the benefit of priority to Korean Patent Application No. 10-2022-0111238 filed on Sep. 2, 2022, the entire contents of which are incorporated herein by reference.

### TECHNICAL FIELD

The present disclosure relates to an anodeless all-solid-state battery which may effectively control local volume expansion due to lithium deposited during charging of the battery.

### BACKGROUND

An all-solid-state battery is a three-layer stack including a cathode active material layer bonded to a cathode current collector, an anode active material layer bonded to an anode current collector, and a solid electrolyte layer disposed between the cathode active material layer and the anode active material layer.

In general, the anode active material layer includes a solid electrolyte in charge of migration of lithium ions in addition to an anode active material, such as graphite. The solid electrolyte has a greater specific gravity than a liquid electrolyte, and thus, the energy density of the all-solid-state battery is lower than that of a lithium ion battery using a liquid electrolyte.

In order to solve the above problem, i.e., to increase the energy density of the all-solid-state battery, research on application of lithium metal as an anode is underway. However, there are many problems to overcome, including research technical problems, such as interfacial bonding, growth of lithium dendrites, etc., and industrial technical problems, such as costs, difficulty in securing a large-scale, etc.

Recently, research on an anodeless all-solid-state battery in which an anode is omitted and lithium ions (Li⁺) are directly precipitated in the form of lithium metal on an anode current collector is ongoing.

The above information disclosed in this Background section is only for enhancement of understanding of the background of the invention and therefore it may contain information that does not form the prior art that is already known in this country to a person of ordinary skill in the art.

### SUMMARY

In preferred aspects, provided is an anodeless all-solid-state battery which may effectively control local volume expansion due to lithium deposited during charging of the battery.

A term “all-solid-state battery” as used herein refers to a rechargeable secondary battery that includes an electrolyte in a solid state. In certain embodiments, the all-solid state battery may be an anodeless all-solid-state battery.

A term “anode-free all-solid-state battery,” “anodeless all-solid-state battery,” “anode-free battery,” or “anodeless battery” as used herein refers to an all-solid-state battery including a bare current collector at its anode side, which is in contrast to a battery that uses lithium metal as an anode. The anodeless all-solid-state battery may include a coating layer on the bare current collector containing materials that induce conduction of lithium ions to a surface of the bare current collector.

In one aspect, the disclosure provides an all-solid-state battery including an anode current collector, an intermediate layer disposed on the anode current collector, a solid electrolyte layer disposed on the intermediate layer, a cathode active material layer disposed on the solid electrolyte layer and including a cathode active material, and a cathode current collector disposed on the cathode active material layer. The intermediate layer may include a carbon particle and a metal particle capable of alloying with lithium, and the carbon particle may include a first carbon material having a spherical shape and a second carbon material having a linear shape.

The first carbon material may suitably include carbon black, graphite, or a combination thereof.

The first carbon material may have a particle size D50 of about 10 nm to 100 nm.

The term “particle size D50” as used herein refers to a median particle size in the particle size distribution and the size is measured by a maximum distance between two points on the surface of the particle.

The second carbon material may suitably include single-walled carbon nanotube, double-walled carbon nanotube, multi-walled carbon nanotube, vapor grown carbon fiber, carbon nanofiber, or combinations thereof.

The second carbon material may have a length of about 0.5 μm to 10 μm.

The second carbon material may have an outer diameter of about 30 nm to 100 nm.

The second carbon material may have an aspect ratio, i.e., a ratio of diameter to the length, of about 5 to 330.

A mass ratio of the first carbon material to the second carbon material may be about 5:95 to 95:5.

The metal particle may include one or more selected from the group consisting of gold (Au), platinum (Pt), magnesium (Mg), palladium (Pd), silicon (Si), silver (Ag), aluminum (Al), bismuth (Bi), tin (Sn), and zinc (Zn).

The intermediate layer may further include a binder, and the intermediate layer may include an amount of about 60% by weight to 85% by weight of the carbon particle, an amount of about 10% by weight to 30% by weight of the metal particle, and an amount of about 1% by weight to 10% by weight of the binder, based on the total weight of the intermediate layer.

A density of the intermediate layer may be about 1.0 g/cc to 1.8 g/cc. The term “density” as used herein refers to a mass density to volume. The density of the intermediate layer refers to the density of the layer including all the required components, i.e. the carbon particles including the first carbon material and the second carbon material and the metal particles, attached to each other to form the intermediate layer.

Other aspects of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an exemplary all-solid-state battery according to an exemplary embodiment of the present disclosure;

FIG. 2 shows an exemplary carbon particle according to an exemplary embodiment of the present disclosure;

FIG. 3A shows a Computed tomography (CT) image showing deposition behavior of lithium according to Example 1;

FIG. 3B shows a CT image showing deposition behavior of lithium according to Comparative Example 1;

FIG. 3C shows a CT image showing deposition behavior of lithium according to Comparative Example 2;

FIG. 3D shows a CT image showing deposition behavior of lithium according to Comparative Example 3;

FIG. 4A shows initial capacities of all-solid-state batteries according to Example 1 and Comparative Examples 1 to 3; and

FIG. 4B shows capacity retentions of the all-solid-state batteries according to Example 1 and Comparative Examples 1 to 3.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawings.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

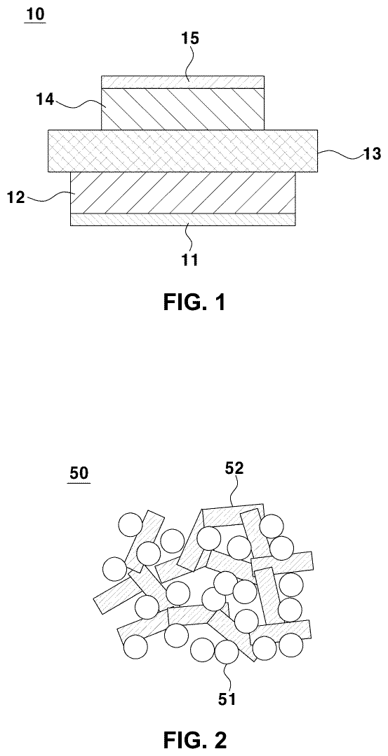

FIG. 1 shows an exemplary all-solid-state battery 10 according to an exemplary embodiment of the present disclosure. The all-solid-state battery 10 may include an anode current collector 11, an intermediate layer 12 disposed on the anode current collector 11, a solid electrolyte layer 13 disposed on the intermediate layer 12, a cathode active material layer 14 disposed on the solid electrolyte layer 13 and including a cathode active material, and a cathode current collector 15 disposed on the cathode active material layer 14.

The anode current collector 11 may be a plate-shaped base material having electrical conductivity. Concretely, the anode current collector 10 may be provided in the form of a sheet, a thin film or foil.

The anode current collector 11 may include a material which does not react with lithium. Concretely, the anode current collector 11 may include nickel (Ni), copper (Cu), stainless steel (SUS), or combinations thereof.

The intermediate layer 12 may include a carbon particle and a metal particle.

FIG. 2 shows the carbon particle 50. The carbon particle 50 may include a first carbon material 51 having a spherical shape, and a second carbon material 52 having a linear shape. A proper amount of pores may be formed in the intermediate layer 12 using a combination of the first carbon material 51 and the second carbon material 52. Thereby, lithium ions are uniformly deposited in the pores during charging of the all-solid-state battery 10, volume expansion of the all-solid-state battery 10 may be suppressed.

The first carbon material 51 and the second carbon material 52 may be simply mixed, or may be compounded through mechanical milling using a ball mill or the like.

The first carbon material 51 may have particles in the form of a spherical or pseudospherical shape. The first caron material may include carbon black, graphite, or a combination thereof.

The carbon black may include, for example, acetylene black, Ketjen black, channel black, furnace black, thermal black, super C, or super P, without being limited to a specific material.

The first carbon material 51 may have a particle size D50 of about 10 nm to 100 nm. When the particle size D50 of the first carbon material 51 is less than about 10 nm, agglomeration of particles may occur in an electrode, and, when the particle size D50 of the first carbon material 51 is greater than about 100 nm, it may be difficult to form a desired density of the intermediate layer 12.

The second carbon material 52 may include single-walled carbon nanotube, double-walled carbon nanotube, multi-walled carbon nanotube, vapor grown carbon fiber, carbon nanofiber, or combinations thereof.

The second carbon material 52 may have a length of about 0.5 μm to 10 μm. The second carbon material 52 may have an outer diameter of about 30 nm to 100 nm. The second carbon material 52 may have an aspect ratio of the diameter (or width) to the length ranging from about 5 to about 330. When the length, outer diameter and aspect ratio of the second carbon material 52 are below the above-described numerical ranges, the density of the intermediate layer 12 is similar to that of the conventional spherical carbon material and thus it may be difficult to achieve a desired effect in the present disclosure, and, when the length, outer diameter and aspect ratio of the second carbon material 52 is greater than the above-described numerical ranges, the intermediate layer 12 has similar specifications to the conventional linear carbon material and thus it may difficult to acquire a meaningful effect.

The carbon particles 50 may include the first carbon material 51 and the second carbon material 52 at a mass ratio of about 5:95 to 95:5. When the mass of the first carbon material 51 is less than about 5, it may be difficult to achieve uniform deposition of lithium, and, when the mass of the first carbon material is greater than about 95, the density of the intermediate layer 12 has a similar to that of the spherical carbon material, and it may be difficult to acquire a desired effect in the present disclosure.

The metal particle may include a metal capable of alloying with lithium. The metal particle may include one or more selected from the group consisting of gold (Au), platinum (Pt), magnesium (Mg), palladium (Pd), silicon (Si), silver (Ag), aluminum (Al), bismuth (Bi), tin (Sn), and zinc (Zn).

At the initial stage of charging of the all-state-battery 10, lithium ions disintercalated from the cathode active material 14 migrate to the intermediate layer 12 through the solid electrolyte layer 13. The lithium ions react with the metal particle, thus producing a metal-lithium alloy. When the all-solid-state battery 10 continues to be charged, lithium is uniformly deposited or precipitated around the metal-lithium alloy, thereby forming a lithium layer 16 between the intermediate layer 12 and the anode current collector 11.

The metal particle may have, for example, a particle size D50 of about 5 μm or less, or about 3 μm or less, or about 1 μm or less, without being limited to a specific particle size D50.

The intermediate layer 12 may further include a binder.

The binder may include, for example, butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC) or the like, without being limited to a specific material.

The intermediate layer may include an amount of about 60% by weight to 85% by weight of the carbon particle, an amount of about 10% by weight to 30% by weight of the metal particle, and an amount of about 1% by weight to 10% by weight of the binder. When the content of the carbon particle is less than about 60% by weight, the content of the metal particle is high and thus, the initial irreversible capacity of the all-solid-state battery 10 may be high, and, when the content of the carbon particle is greater than about 85% by weight, behavior of deposition of lithium may not be uniform. When the content of the metal particle is less than about 10% by weight, it may be difficult to form an alloy with lithium ions, and, when the content of the metal particle is greater than about 30% by weight, the content of the carbon particles may be relatively reduced and the volume of the intermediate layer 12 may be increased.

The density of intermediate layer 12 may be about 1.0 g/cc to 1.8 g/cc. The density of the intermediate layer 12 may be calculated by dividing the total weight of the intermediate layer 12 by the volume of the intermediate layer 12. When the density of the intermediate layer 12 is less than about 1.0 g/cc, lithium may not be uniformly deposited, and, when the density of the intermediate layer 12 is greater than about 1.8 g/cc, deposition behavior of lithium depending on current density may be varied.

The solid electrolyte layer 13 is interposed between the cathode active material layer 14 and the intermediate layer 12, and may conduct lithium ions.

The solid electrolyte layer 13 may include a solid electrolyte having lithium ion conductivity.

The solid electrolyte may include one or more selected from the group consisting of oxide-based solid electrolytes, sulfide-based solid electrolytes, and polymer solid electrolytes.

Particularly, a sulfide-based solid electrolyte having high lithium ion conductivity may be used. The sulfide-based solid electrolytes may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—SiS₂, Li₂S—SiS₂—LiBr, Li₂S—SiS₂—LiCl, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li inGeP₂S₁₂, etc., without being limited thereto.

The oxide-based solid electrolytes may include perovskite-type LLTO (Li₃ₓLa_{2/3-x}TiO₃), phosphate-based NASICON-type LATP(Li₁₊ₓAlₓTi₂₋ₓ(PO₄)₃), etc.

The polymer electrolytes may include gel polymer electrolytes, solid polymer electrolytes, etc.

The cathode active material layer 14 may include a cathode active material, a solid electrolyte, a conductive material, a binder, etc.

The cathode active material may reversibly intercalate and disintercalate lithium ions. The cathode active material may include an oxide active material.

The oxide active material may include a rock salt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The solid electrolyte may include an oxide-based solid electrolyte or a sulfide-based solid electrolyte. Particularly, a sulfide-based solid electrolyte having high lithium ion conductivity may be used. The sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), or Li₁₀GeP₂S₁₂, without being limited to a specific material.

The conductive material may include carbon black, conductive graphite, ethylene black, graphene, or the like.

The binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like.

The cathode current collector 15 may be a plate-shaped base material having electrical conductivity. The cathode current collector 15 may include aluminum foil.

### EXAMPLE

Hereinafter, the present disclosure will be described in more detail through the following examples. The following examples serve merely to exemplarily describe the present disclosure, and are not intended to limit the scope of the invention.

### Example 1

Super C having a particle size D50 of about 50 nm was used as a first carbon material which has a spherical shape. Multi-walled carbon nanotube having a length of about 0.5 μm to 2 μm and an outer diameter of about 50 nm to 80 nm were used as a second carbon material which has a linear shape. Carbon particle were prepared by mixing the first carbon material and the second carbon material in a mass ratio of 7:3. Silver (Ag) particles were prepared as metal particle. An intermediate layer was formed by applying a slurry including the carbon particle, the metal particle and the binder to an anode current collector and then drying a resultant product. The intermediate layer includes about 70% by weight of the carbon particle, about 25% by weight of the metal particle, and about 5% by weight of the binder.

A stack having the structure shown in FIG. 1 was prepared by stacking a solid electrolyte layer, a cathode active material layer and a cathode current collector on the intermediate layer. The solid electrolyte includes a sulfide-based solid electrolyte. The cathode active material layer includes a nickel-cobalt-manganese-based cathode active material.

### Comparative Example 1

An intermediate layer was manufactured using a linear carbon material alone as carbon particle. A stack was prepared using the same method as in Example 1 except that multi-walled carbon nanotube having a length of about 10 μm to 20 μm and an outer diameter of about 50 nm to 80 nm were used as the carbon particle.

### Comparative Example 2

An intermediate layer was manufactured using a linear carbon material alone as carbon particle. A stack was prepared using the same method as in Example 1 except that multi-walled carbon nanotube having a length of about 0.5 μm to 2 μm and an outer diameter of about 50 nm to 80 nm were used as the carbon particle.

### Comparative Example 3

An intermediate layer was manufactured using a spherical carbon material alone as carbon particle. A stack was prepared using the same method as in Example 1 except that Super C having a particle size D50 of about 50 nm was used as the carbon particle.

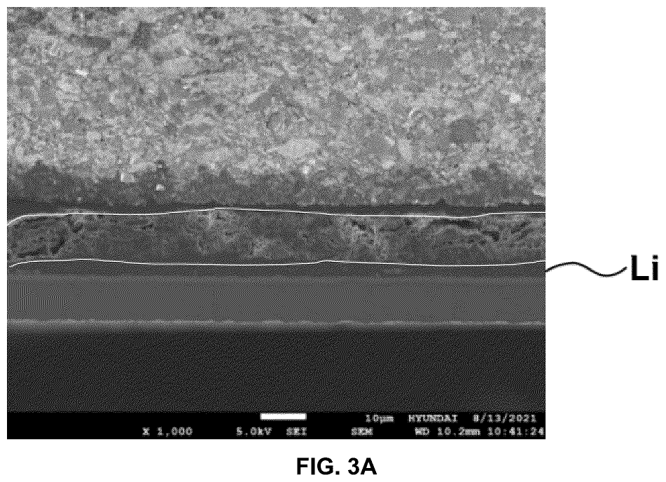

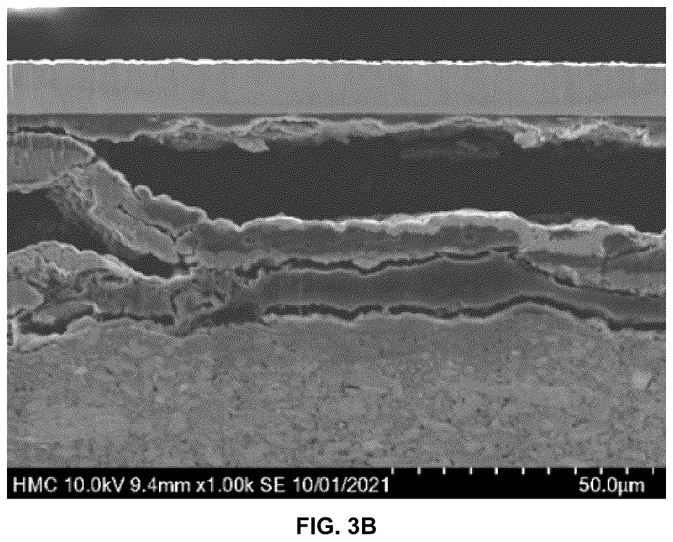

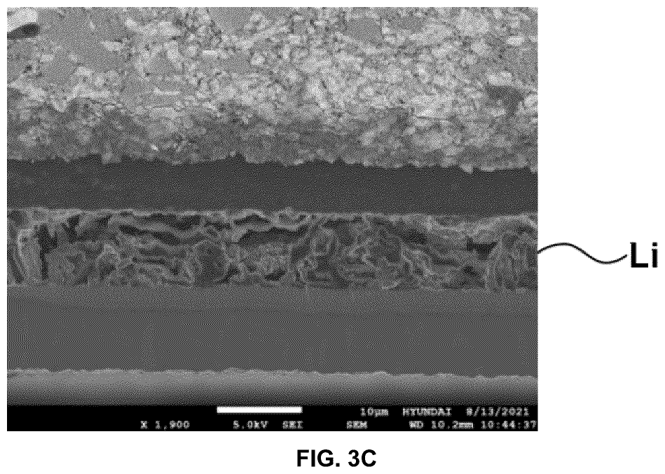

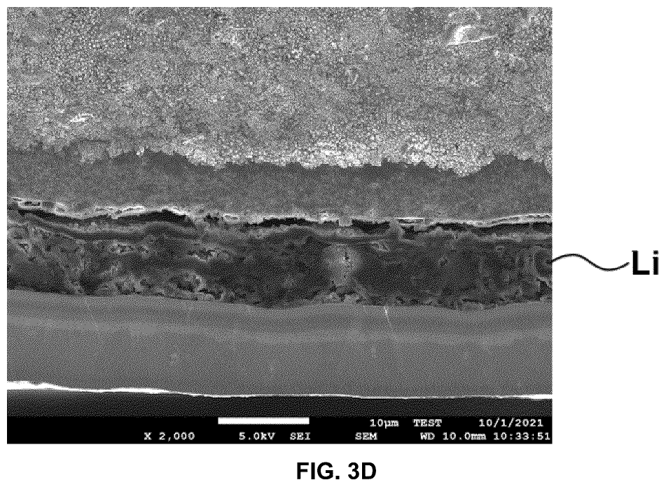

Deposition behaviors of lithium in the respective stacks according to Example 1 and Comparative Examples 1 to 3 were observed by charging the respective stacks. FIG. 3A shows a Computed tomography (CT) image showing the deposition behavior of lithium according to Example 1. FIG. 3B shows a CT image showing the deposition behavior of lithium according to Comparative Example 1. FIG. 3C shows a CT image showing the deposition behavior of lithium according to Comparative Example 2. FIG. 3D shows a CT image showing the deposition behavior of lithium according to Comparative Example 3. As shown in FIGS. 3A-3D, lithium was not uniformly deposited in the stacks according to Comparative Examples 1 to 3.

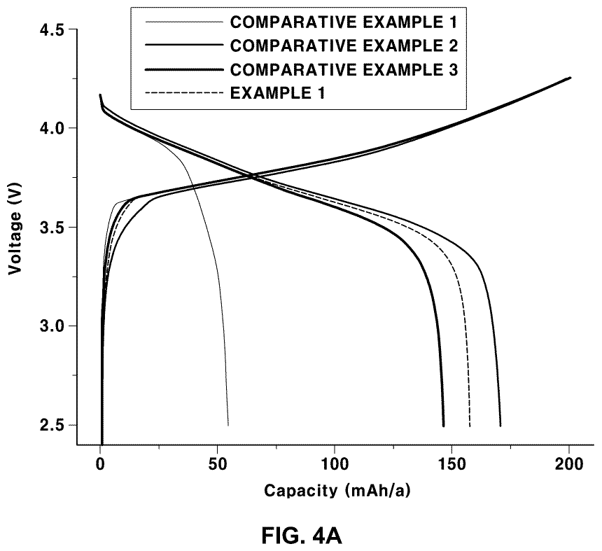

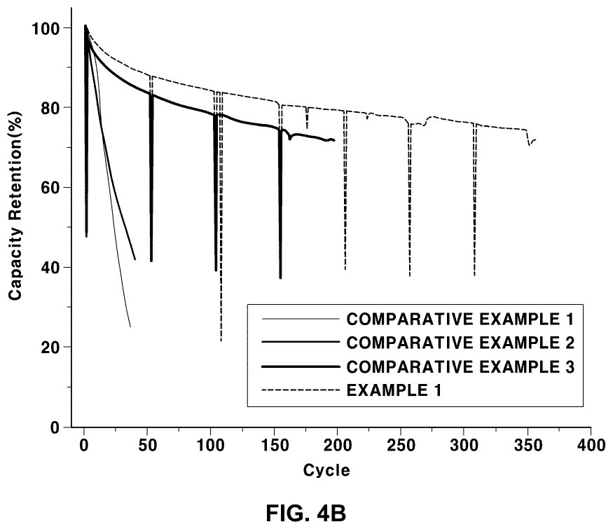

FIG. 4A shows initial capacities of the stacks according to Example 1 and Comparative Examples 1 to 3. FIG. 4B shows capacity retentions of the stacks according to Example 1 and Comparative Examples 1 to 3 and the stack according to Comparative Example 2 exhibited an excellent initial capacity, but exhibited a capacity retention of about 50% or less after about 50 charge and discharge cycles. The reason for this is that the deposition behavior of lithium was not uniform. As shown in FIGS. 4A-4B, stack according to Example 1 exhibited an excellent initial capacity, and maintained about 80% of the initial capacity even after about 350 charge and discharge cycles.

According to various exemplary embodiments, the anodeless all-solid-state battery as described herein may effectively control local volume expansion due to lithium deposited during charging of the battery.

Further, according to various exemplary embodiments of the present disclosure, the anodeless all-solid-state battery in which lithium is uniformly deposited on an anode current collector when the battery is charged can be provided.

Moreover, according to various exemplary embodiments of the present disclosure, the anodeless all-solid-state battery which may have a reduced initial irreversible capacity can be provided.

In addition, according to various exemplary embodiments of the present disclosure, the anodeless all-solid-state battery may have excellent durability and efficiency.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An all-solid-state battery comprising:
an anode current collector;
an intermediate layer disposed on the anode current collector;
a solid electrolyte layer disposed on the intermediate layer;
a cathode active material layer disposed on the solid electrolyte layer and comprising a cathode active material; and
a cathode current collector disposed on the cathode active material layer,
wherein:
the intermediate layer comprises a carbon particle and a metal particle capable of alloying with lithium; and
the carbon particle comprises a first carbon material having a spherical shape and a second carbon material having a linear shape.

2. The all-solid-state battery of claim 1, wherein the first carbon material comprises carbon black, graphite, or any combination thereof.

3. The all-solid-state battery of claim 1, wherein the first carbon material has a particle size D50 of about 10 nm to 100 nm.

4. The all-solid-state battery of claim 1, wherein the second carbon material comprises single-walled carbon nanotube, double-walled carbon nanotube, multi-walled carbon nanotube, vapor grown carbon fiber, carbon nanofiber, or any combination thereof.

5. The all-solid-state battery of claim 1, wherein the second carbon material has a length of about 0.5 μm to 10 μm.

6. The all-solid-state battery of claim 1, wherein the second carbon material has an outer diameter of about 30 nm to 100 nm.

7. The all-solid-state battery of claim 1, wherein the second carbon material has an aspect ratio of about 5 to 330.

8. The all-solid-state battery of claim 1, wherein a mass ratio of the first carbon material to the second carbon material is about 5:95 to 95:5.

9. The all-solid-state battery of claim 1, wherein the metal particle comprises one or more selected from the group consisting of gold (Au), platinum (Pt), magnesium (Mg), palladium (Pd), silicon (Si), silver (Ag), aluminum (Al), bismuth (Bi), tin (Sn), and zinc (Zn).

10. The all-solid-state battery of claim 1, wherein the intermediate layer further comprises a binder,
wherein the intermediate layer comprises:
an amount of about 60% by weight to 85% by weight of the carbon particle;
an amount of about 10% by weight to 30% by weight of the metal particle; and
an amount of about 1% by weight to 10% by weight of the binder,
based on the total weight of the intermediate layer.

11. The all-solid-state battery of claim 1, wherein a density of the intermediate layer is about 1.0 g/cc to 1.8 g/cc.

12. A vehicle comprising an all-solid-state battery of claim 1.
